(19) United States
(12) Patent Application Publication
(10) Pub. No.: US 2011/0148728 A1
(43) Pub. Date: Jun. 23, 2011

(54) CHIP ANTENNA

(75) Inventor: Hiroki YOSHIOKA, Kawasaki-shi (JP)

(73) Assignee: MITSUMI ELECTRIC CO., LTD., Tama-shi (JP)

(21) Appl. No.: 12/971,206

(22) Filed: Dec. 17, 2010

(30) Foreign Application Priority Data
Dec. 22, 2009 (JP) 2009-289960

(51) Int. Cl. H01Q 1/00; H01Q 1/36

(52) U.S. Cl. 343/787

(57) ABSTRACT

Disclosed is a chip antenna comprising: a base portion including a dielectric, a magnetic substance or a magnetic dielectric; a spiral antenna electrode which is opposed to a ground portion and which is provided inside the base portion; and a power feeding connecting terminal to feed power to the antenna electrode, wherein a first side portion including an outermost peripheral end of the antenna electrode, or a second side portion connected to the first side portion including the outermost peripheral end, is disposed at a position closest to the ground portion at a predetermined distance away from the ground portion, and the power feeding connecting terminal is connected to a side portion extending in a direction substantially perpendicular to the ground portion.

### BACKGROUND OF THE INVENTION

1. Field of the Invention

The present invention relates to a chip antenna.

2. Description of the Related Art

Conventionally, an antenna for wireless communication provided in an electronic device is known. This electronic device is a portable device such as a cellular phone, and it has been desired to reduce the antenna in size.

As an antenna for realizing miniaturization, a dielectric antenna is known. The dielectric antenna includes an antenna electrode (antenna element) and a dielectric provided around the antenna electrode. A length of the antenna may be shortened by a wavelength shortening effect of radio wave generated by a relative dielectric constant of the dielectric, and the dielectric antenna can be reduced in size.

As a configuration of the dielectric antenna for realizing the miniaturization, there is a known antenna in which a pattern of an antenna electrode is formed sterically or multilayered (multilayered meander, helical and the like) (see Japanese Patent Application Laid-open Publication No. 11-297532, for example).

As another configuration of the dielectric antenna for realizing the miniaturization, there is a known antenna having a spiral antenna electrode (see PCT Publication No. 01/006596, for example).

However, in the case of the conventional dielectric antenna in which an antenna electrode is formed sterically or as multilayered, a high dimensional precision and a high producing technique of the antenna electrode are required.

In the case of the conventional spiral dielectric antenna, since the antenna electrode is provided on the same plane surface, productivity of the antenna is preferable. However, a tip end of the spiral antenna electrode is used as a power feeding point. Therefore, impedance match and the antenna efficiency (radiation efficiency) are largely deteriorated.

### SUMMARY OF THE INVENTION

It is an object of the present invention to reduce an antenna in size, and to enhance the impedance match and the antenna efficiency.

According to an aspect of the present invention, there is provided a chip antenna comprising:

a base portion including a dielectric, a magnetic substance or a magnetic dielectric;

a spiral antenna electrode which is opposed to a ground portion and which is provided inside the base portion; and

a power feeding connecting terminal to feed power to the antenna electrode, wherein

a first side portion including an outermost peripheral end of the antenna electrode, or a second side portion connected to the first side portion including the outermost peripheral end, is disposed at a position closest to the ground portion at a predetermined distance away from the ground portion, and

the power feeding connecting terminal is connected to a side portion extending in a direction substantially perpendicular to the ground portion.

### BRIEF DESCRIPTION OF DRAWINGS

The above and other objects, advantages and features of the present invention will become more fully understood from the detailed description given hereinbelow and the appended drawings and tables which are given byway of illustration only, and thus are not intended as a definition of the limits of the present invention, and wherein:

FIG. 1 is a perspective view of a chip antenna and a substrate of an embodiment according to the present invention;

FIG. 2 is a see through view of the chip antenna and the substrate of the embodiment;

FIG. 3A is a see through plan view of the chip antenna of the embodiment;

FIG. 3B is a see through side view of the chip antenna of the embodiment;

FIG. 4 is a diagram showing an antenna electrode and first to seventh positions as power feeding connecting positions;

FIG. 5 is a diagram showing a return loss with respect to frequency of a chip antenna when electricity is fed at the first to seventh positions;

FIG. 6 is a diagram showing the chip antenna and a length thereof of the embodiment;

FIG. 7A is a plan view of another first spiral chip antenna;

FIG. 7B is a plan view of another second spiral chip antenna;

FIG. 7C is a plan view of another third spiral chip antenna;

FIG. 7D is a plan view of another fourth spiral chip antenna;

FIG. 8 is a diagram showing a return loss with respect to frequency of the chip antenna of the embodiment and other first to fourth spiral chip antennas;

FIG. 9 is a diagram showing a height of the antenna electrode in the chip antenna of the embodiment;

FIG. 10 is a diagram showing a return loss with respect to frequency of the chip antenna of the embodiment when the height of the antenna electrode is changed;

FIG. 11 is a diagram showing a height of the antenna electrode in the chip antenna having a height higher than that of the chip antenna of the embodiment;

FIG. 12 is a diagram showing a return loss with respect to frequency of a chip antenna having a height higher than that of the chip antenna of the embodiment when the height of the antenna electrode is changed;

FIG. 13A is a diagram showing a positional relation between the chip antenna of the embodiment and a ground portion;

FIG. 13B is a diagram showing a positional relation between a normal spiral chip antenna and the ground portion;

FIG. 14 is a diagram showing a return loss with respect to frequency in the chip antenna when a distance between the chip antenna and the ground portion is changed;

FIG. 15A is a plan view of a chip antenna according to a first modification;

FIG. 15B is a sectional view of the chip antenna of the first modification taken along the line XVb-XVb in FIG. 15A;

FIG. 16A is a plan view of a chip antenna according to a second modification;

FIG. 16B is a side view of the chip antenna of the second modification;

FIG. 17A is a plan view of a chip antenna according to a third modification;

FIG. 17B is a side view of the chip antenna of the third modification;

Table 1 shows the antenna efficiency of the chip antenna when the power feeding connecting position is changed from the position P1 to the position P7;

Table 2 shows the antenna efficiencies of the chip antennas 10A, 10B, 10C and 10D, and that of the chip antenna 10;

Table 3 shows the antenna efficiencies of the chip antenna 10 when the height is changed from the height H1 to the height H7; and

Table 4 shows the antenna efficiencies of the chip antennas 10 and 10F when the distances d are changed.

### DETAILED DESCRIPTION OF THE PREFERRED EMBODIMENTS

An embodiment as well as first, second and third modifications of the present invention will be described in detail in this order with reference to the accompanying drawings. The scope of the invention is not limited to the illustrated examples.

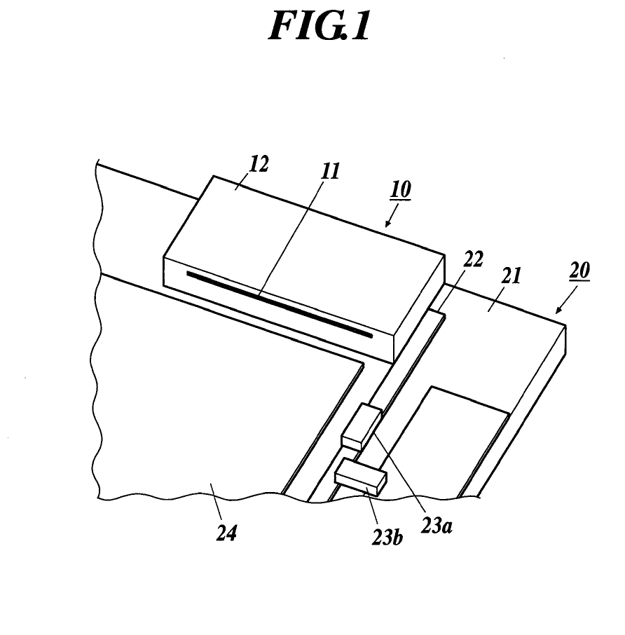

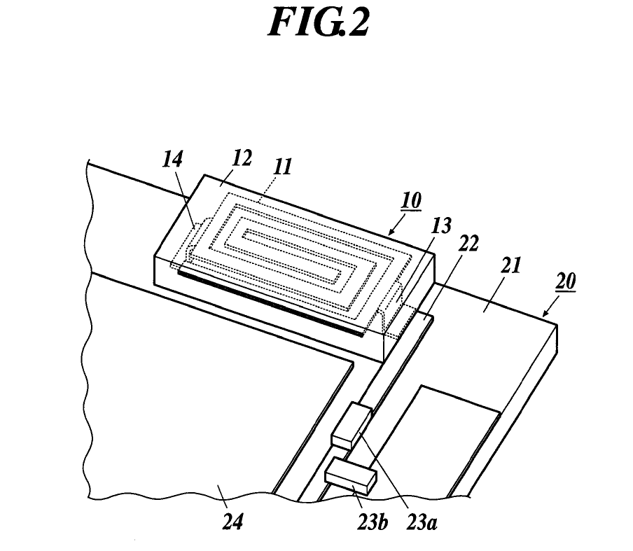

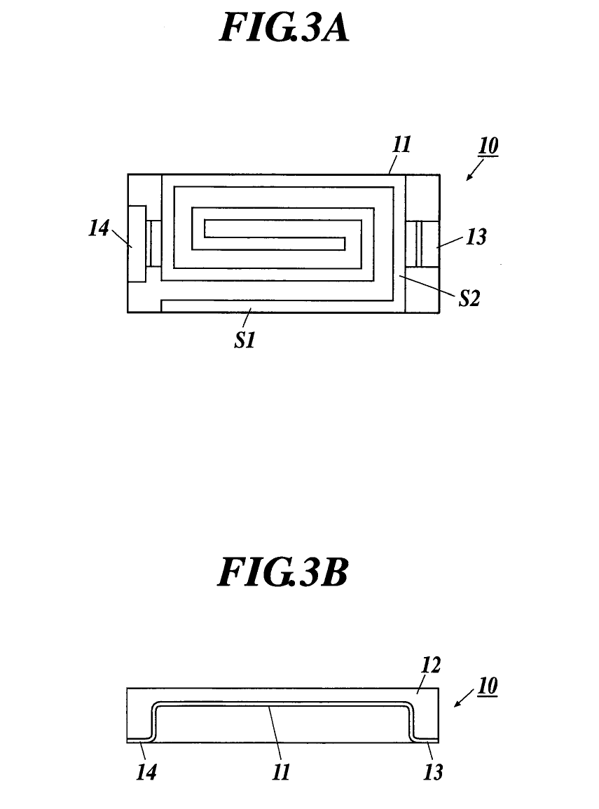

The embodiment of the invention will be described with reference to FIGS. 1 to 14. First, an apparatus configuration of a chip antenna 10 of the embodiment will be described with reference to FIGS. 1 to 3B. FIG. 1 shows a perspective configuration of the chip antenna 10 and a substrate 20 of the embodiment. FIG. 2 shows, in a see through manner, a configuration of the chip antenna 10 and a substrate 20. FIG. 3A shows, in a see through manner, a plane configuration of the chip antenna 10. FIG. 3B shows, in a see through manner, a configuration of the chip antenna 10 as viewed from side.

The chip antenna 10 of the embodiment will be described as a wireless antenna which is for GPS (Global Positioning System) communication and which has resonance frequency of 1.575 [GHz], however, the invention is not limited to this, and the chip antenna 10 may be a wireless antenna having a different communication standard or different resonance frequency.

As shown in FIGS. 1 and 2, the chip antenna 10 is provided on the substrate 20. The substrate 20 is incorporated in an electronic device having a radio communication function through the chip antenna 10, such as a cellular phone and a PDA (Personal Digital Assistant).

The substrate 20 includes a substrate portion 21, a power feeding path portion 22, matching circuits 23a and 23b and a ground portion 24. The substrate portion 21 is an insulative circuit substrate body. The power feeding path portion 22 is provided on the substrate portion 21, and is a power feeding path extending from the chip antenna 10 to a module (not shown) which feeds power to the chip antenna 10. The power feeding path portion 22 is a conductor made of a copper foil, for example.

The matching circuit 23a is provided in the power feeding path portion 22 in series, and is a circuit portion for matching impedance of the chip antenna 10. The matching circuit 23b is provided in the power feeding path portion 22 in parallel, and is a circuit portion for matching impedance of the chip antenna 10. The matching circuits 23a and 23b are formed from inductors for example.

Resonance frequency of the chip antenna 10 is adjusted to a value higher than frequency (1.575 [GHz]) used for communication. The matching circuits 23a and 23b shift the resonance frequency of the chip antenna 10 to frequency used for the communication. The ground portion 24 is provided on the substrate portion 21, and is a grounded conductor such as copper foil.

As shown in FIGS. 3A and 3B, the chip antenna 10 includes an antenna electrode 11, a base portion 12, a power feeding connecting terminal 13 and an installation terminal 14. The antenna electrode 11 is formed from a conductor, and is an antenna element which is rectangularly and spirally wound in a counterclockwise direction from its outermost periphery toward its center. The chip antenna 10 is disposed such that a straight side portion S1 including the outermost peripheral end is in parallel to an upper side of the ground portion 24 and the side portion S1 is disposed at a position closest to the ground portion 24 at a predetermined distance away from the ground portion 24.

The base portion 12 is formed from a rectangular parallelepiped dielectric. The antenna electrode 11, the power feeding connecting terminal 13 and the installation terminal 14 are provided inside the base portion 12. A relative dielectric constant of the base portion 12 is in a range of 8 to 15 for example. The base portion 12 is made of resin such as LCP (Liquid Crystal Polymer) in which ceramic is mixed.

Since the antenna electrode 11 has the spiral shape, miniaturization effect by the permittivity of the base portion 12 is enhanced and therefore, the antenna can be reduced in size even if the permittivity of the base portion 12 is low and capacitance between the chip antenna 10 (antenna electrode 11) and the ground portion 24 is reduced. That is, the radiation efficiency (antenna efficiency) of the chip antenna 10 is less prone to be deteriorated even when space is saved.

The power feeding connecting terminal 13 is a conductor which is electrically connected to the antenna electrode 11 and the power feeding path portion 22, and supports the antenna electrode 11 on the substrate portion 21. The power feeding connecting terminal 13 is connected to a central position of a side portion S2 of the antenna electrode 11. The side portion S2 is connected to the straight side portion S1 including the outermost peripheral end of the antenna electrode 11. The side portion S2 is straight and extends in a direction perpendicular (substantially perpendicular) to the upper side of the ground portion 24. A connection point between the power feeding connecting terminal 13 and the antenna electrode 11 is referred to as a power feeding connecting position.

The installation terminal 14 is a conductor which is electrically connected to the antenna electrode 11, and supports the antenna electrode 11 on the substrate portion 21. The installation terminal 14 is connected to a side portion which is opposite from the side portion S2 of the antenna electrode 11. A distance between the upper side of the ground portion 24 and a surface of the base portion 12 on the side of the ground portion 24 is 0.3 [mm].

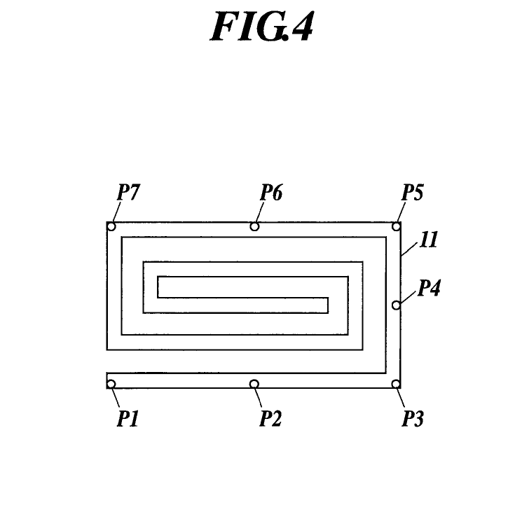

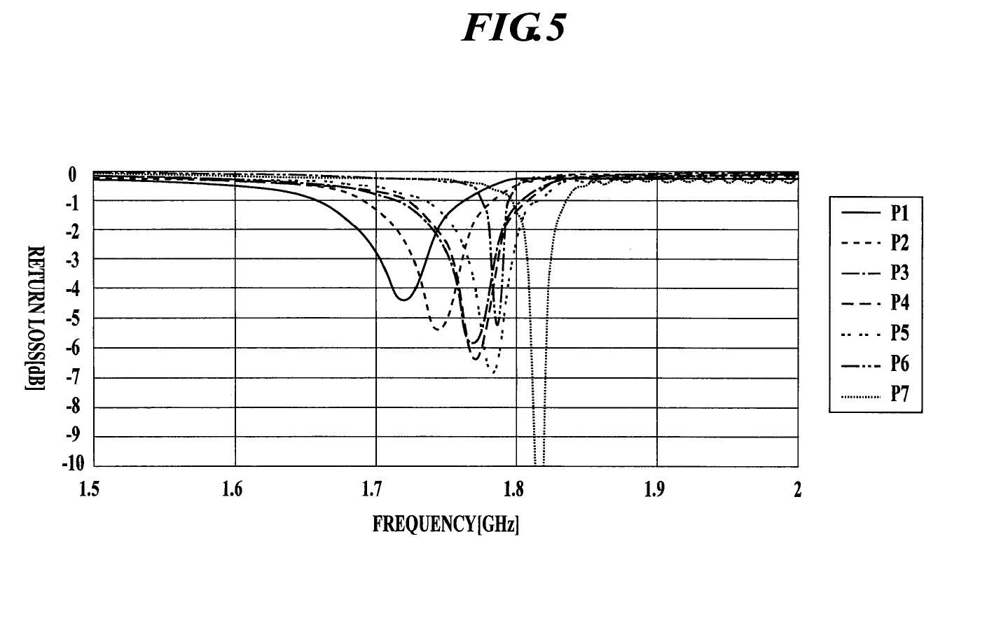

Next, a relation between the antenna characteristic and the power feeding connecting position of the chip antenna 10 will be described with reference to FIGS. 4 and 5. FIG. 4 shows the antenna electrode 11 and positions P1 to P7 as the power feeding connecting positions. FIG. 5 shows a return loss with respect to frequency of the chip antenna when power is fed at the positions P1 to P7.

As shown in FIG. 4, a simulation of the antenna efficiency (radiation efficiency) of the chip antenna and the return loss with respect to frequency when the power feeding connecting position of the antenna electrode 11 of the chip antenna 10 was changed from the position P1 to the position P7 was performed.

The antenna efficiency of the chip antenna when the power feeding connecting position is changed from the position P1 to the position P7 is as shown in the attached Table 1. This antenna efficiency is obtained when the frequency is 1.575 [GHz].

According to Table 1, the antenna efficiency improves as the power feeding connecting position is separated from the position P1 as the spiral end. However, the return loss with respect to frequency becomes narrow-band if the power feeding connecting position approaches the position P6 as shown in FIG. 5, and it becomes difficult to match the impedance. Therefore, it can be said that preferable characteristic can be obtained when the power feeding connecting position is located around the positions P3 to P5 in terms of the antenna efficiency and the impedance match. Thus, in the antenna electrode 11, it is preferable that the power feeding connecting position is on the side portion S2 which corresponds to the positions P3 to P5.

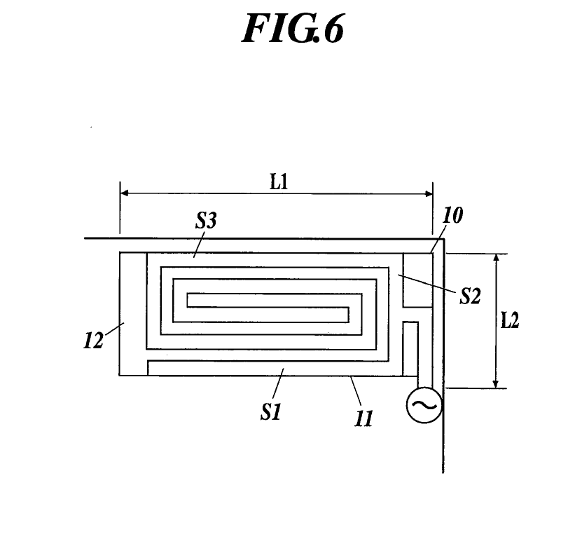

Next, a relation between the antenna shape and the power feeding connecting position will be described with reference to FIG. 6. FIG. 6 shows the chip antenna 10 and its lengths L1 and L2.

The length of the chip antenna 10 (base portion 12) in a direction parallel to the upper side of the ground portion 24 is defined as L1, and the length thereof in a direction perpendicular to the upper side of the ground portion 24 is defined as L2. The chip antenna 10 of the embodiment has a relation of L1>L2. A first side portion (lower side in the drawing) from the outermost peripheral end of the antenna electrode 11 is defined as a side portion S1, a second side portion (right side in the drawing) is defined as a side portion S2, and a third side portion (upper side in the drawing) is defined as a side portion S3.

Here, lengths L1 and L2 of a chip antenna were changed to L1=L2, and a simulation of the antenna efficiency and a return loss with respect to frequency was also performed for this chip antenna. As a result, when the power feeding connecting position was located at the side portion S2, the antenna efficiency and the impedance match became preferable. Similarly, when the power feeding connecting position was located on the side portions S1 and S3, the antenna efficiency and the impedance match were deteriorated.

Lengths L1 and L2 of a chip antenna were changed to L1<L2, and a simulation of the antenna efficiency and a return loss with respect to frequency was further performed for this chip antenna. As a result, when the power feeding connecting position was located on the side portion S2, the antenna efficiency and the impedance match became slightly preferable, and when the power feeding connecting position was located on a midpoint of the side portion S2, the same effect as that in the case of the chip antenna when L1≧L2 was obtained. In the chip antenna of L1<L2, when the power feeding connecting position was located on the side portion S1 or S3, the antenna efficiency and the impedance match were deteriorated.

Therefore, not only when the lengths L1 and L2 of the chip antenna were changed, but also when the power feeding connecting position was located on the side portion S2, the preferable antenna efficiency and impedance match were obtained as a result.

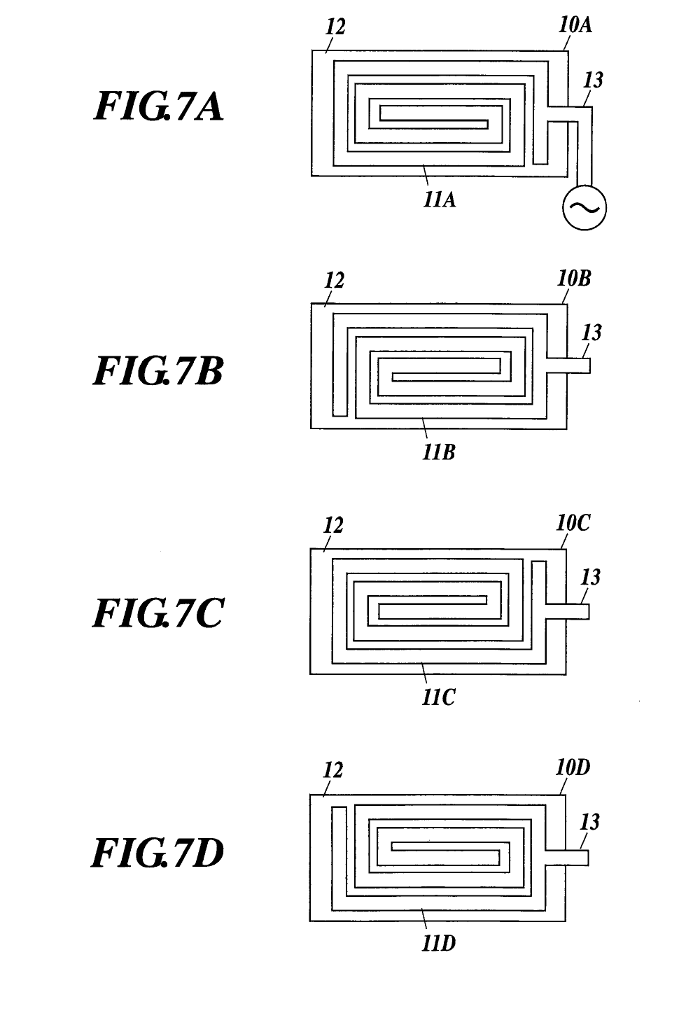

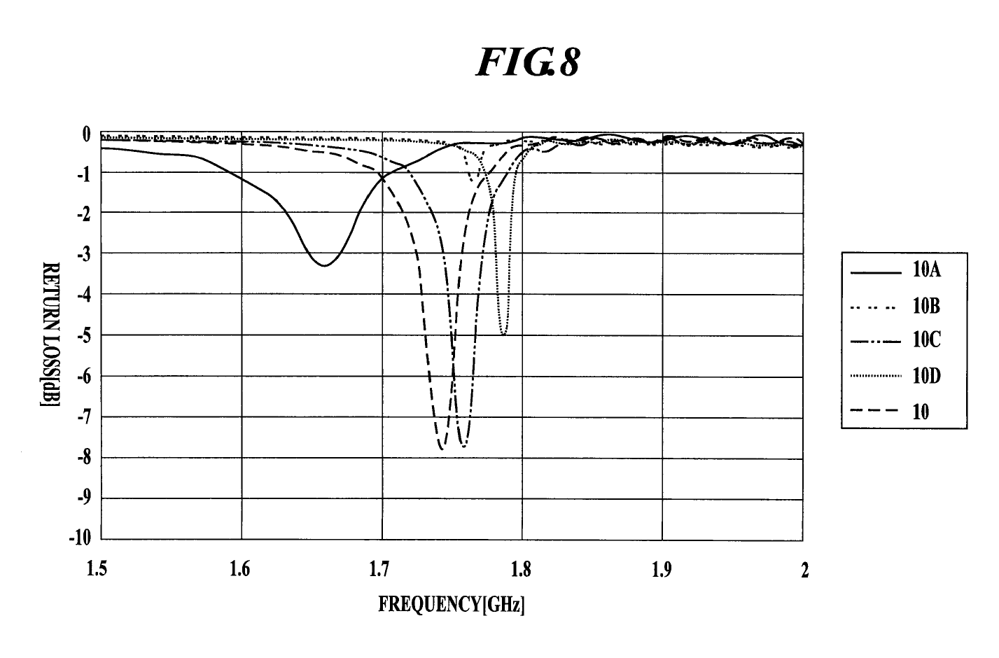

Next, a relation between the spiral shape of the chip antenna and the antenna characteristic will be described with reference to FIGS. 7A to 8. FIG. 7A shows a configuration of a chip antenna 10A as viewed from above. FIG. 7B shows a configuration of a chip antenna 10B as viewed from above. FIG. 7C shows a configuration of a chip antenna 10C as viewed from above. FIG. 7D shows a configuration of a chip antenna 10D as viewed from above. FIG. 8 shows return losses with respect to frequency in the chip antennas 10A to 10D, and 10.

Here, the chip antenna 10, and the chip antennas 10A, 10B, 10C and 10D of spiral antenna electrodes which are different from the antenna electrode 11 of the chip antenna 10 are compared with each other. Each of the chip antennas 10A, 10B, 10C and 10D includes the base portion 12 and the power feeding connecting terminal 13 (installation terminal 14) in the same manner as in the chip antenna 10. In FIGS. 7A to 7D, the ground portion 24 is disposed on a lower side of each of the antennas 10A, 10B, 10C and 10D in the same manner as in the chip antenna 10 shown in FIGS. 1 and 2.

As shown in FIG. 7A, the chip antenna 10A includes an antenna electrode 11A, the base portion 12 and the power feeding connecting terminal 13. The antenna electrode 11A has a spiral shape which is wound in a counterclockwise direction from its outermost periphery toward its center on a plane, and a straight side portion thereof including the outermost peripheral end is on the right side in the drawing. As shown in FIG. 7B, the chip antenna 10B includes an antenna electrode 11B, the base portion 12 and the power feeding connecting terminal 13. The antenna electrode 11B has a spiral shape which is wound in a clockwise direction from its outermost periphery toward its center on a plane, and a straight side portion thereof including the outermost peripheral end is on the left side in the drawing.

As shown in FIG. 7C, the chip antenna 10C includes an antenna electrode 11C, the base portion 12 and the power feeding connecting terminal 13. The antenna electrode 11C has a spiral shape which is wound in the clockwise direction from its outermost periphery toward its center on a plane, and a straight first side portion thereof including the outermost peripheral end is on the right side in the drawing. In the antenna electrode 11C, a straight second side portion connected to the straight first side portion including the outermost peripheral end is disposed at a position closest to the ground portion 24 at a predetermined distance away from the ground portion 24.

As shown in FIG. 7D, the chip antenna 10D includes an antenna electrode 11D, the base portion 12 and the power feeding connecting terminal 13. The antenna electrode 11D has a spiral shape which is wound in the counterclockwise direction from its outermost periphery toward its center on a plane, and a straight side portion thereof including the outermost peripheral end is on the left side in the drawing. In the antenna electrode 11D, a straight second side portion connected to a straight first side portion including the outermost peripheral end is disposed at a position closest to the ground portion 24 at a predetermined distance away from the ground portion 24. The power feeding connecting terminal 13 with respect to each of the antenna electrodes 11A, 11B, 11C and 11D of the chip antennas 10A, 10B, 10C and 10D is connected to a midpoint of a right side portion of the outermost periphery of each of the antenna electrodes 11A, 11B, 11C and 11D in the drawing. The right side portion of the outermost periphery is a side portion extending in a direction perpendicular (substantially perpendicular) to the upper side of the ground portion 24.

A simulation of the antenna efficiency and a return loss with respect to frequency was performed for each of the chip antennas 10A, 10B, 10C and 10D, and the chip antenna 10. The antenna efficiencies of the chip antennas 10A, 10B, 10C and 10D, and that of the chip antenna 10 are as shown in the attached Table 2. This antenna efficiency is obtained when the frequency is 1.575 [GHz].

According to Table 2, the antenna efficiency is preferable in the chip antennas 10B, 10D and 10. On the other hand, as shown in FIG. 8, a return loss (impedance match) with respect to frequency is preferable in the chip antennas 10A, 10C and 10, and the return loss is most preferable in the chip antenna 10A. If both the antenna efficiency and impedance match are taken into account, it can be found that the chip antenna 10 of the embodiment is most preferable and the chip antennas 10C and 10D are also preferable. The chip antenna 10B has preferable antenna efficiency although its return loss is not preferable (narrow-band).

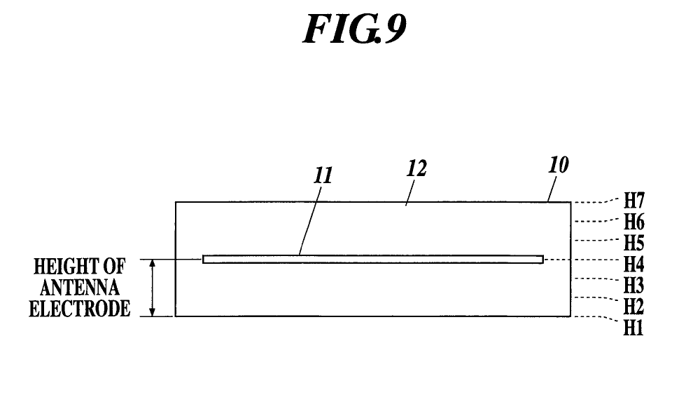

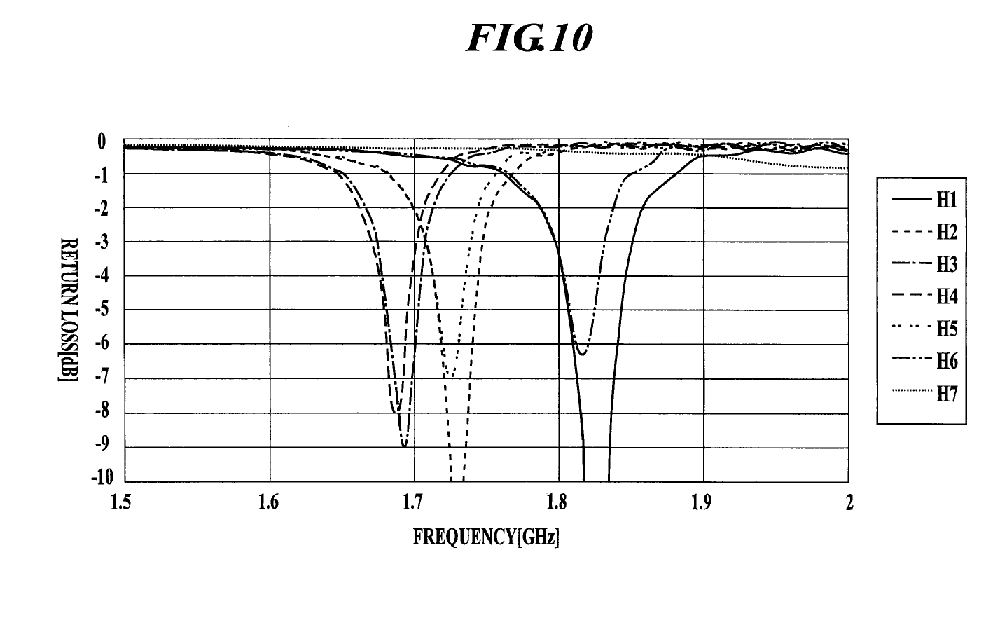

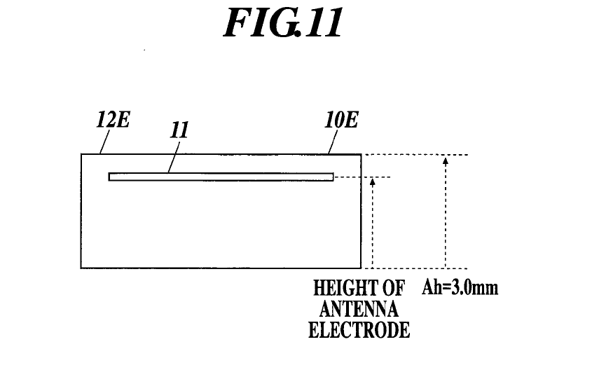

Next, a relation between antenna characteristic and a height of the antenna electrode 11 in the base portion 12 of the chip antenna 10 will be described with reference to FIGS. 9 and 10. FIG. 9 shows a height of the antenna electrode 11 in the chip antenna 10. FIG. 10 shows a return loss with respect to frequency in the chip antenna 10 when the height of the antenna electrode 11 is changed.

As shown in FIG. 9, a simulation of the antenna efficiency and the return loss with respect to frequency when the height of the antenna electrode 11 in the base portion 12 of the chip antenna 10 was changed from a height H1 to a height H7 was performed. A height from a lower surface to an upper surface of the base portion 12 is divided into the heights H1 to H7. The height of the base portion 12 is 1 [mm].

Antenna efficiencies of the chip antenna 10 when the height is changed from the height H1 to the height H7 is as shown in the attached Table 3. This antenna efficiency is obtained when the frequency is 1.575 [GHz].

According to Table 3, the antenna efficiency is poor when the height of the antenna electrode 11 is low, however, the higher the antenna electrode 11 is, the more preferable the antenna efficiency becomes. That is, at the height H7, the antenna efficiency of the chip antenna 10 is most preferable. However, the return loss with respect to frequency is preferable at the heights H2, H3, H4 and H5 as shown in FIG. 10. At the height H1, there is a resonance portion (drop) when the return loss is out of frequency range (2 [GHz] or higher) in FIG. 10, and it is difficult to shift the resonance portion to the communication frequency (1.575 [GHz]) by the matching circuits 23a and 23b. Therefore, if the antenna efficiency and the impedance match are taken into account, it is preferable that the height of the antenna electrode 11 is in a range from approximately a center (heights H3 and H4) of the base portion 12 to a position (height H2) not projecting from the upper surface.

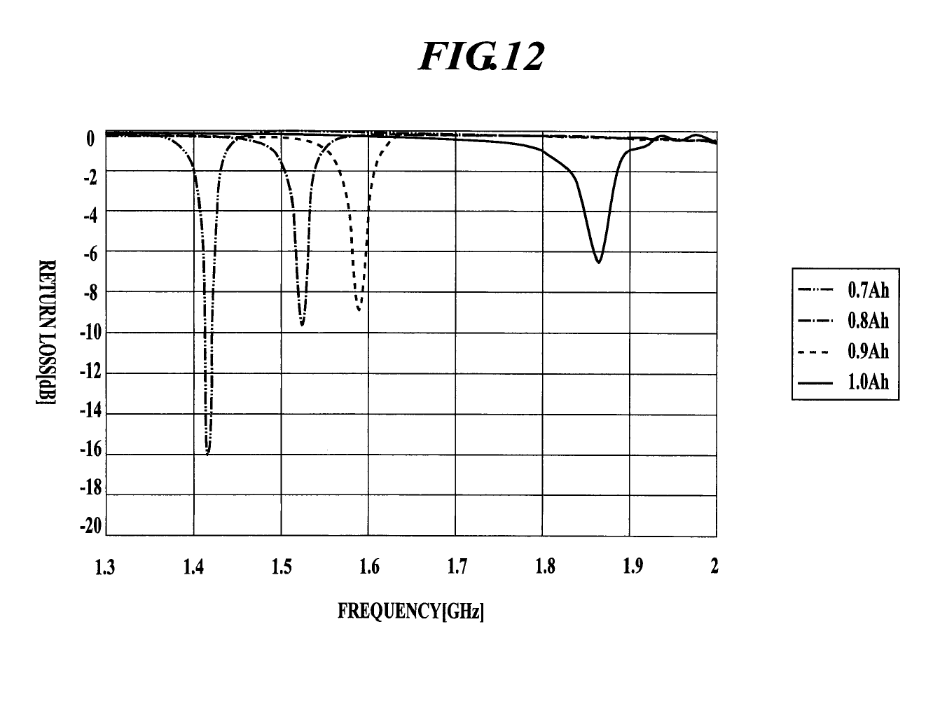

Next, a relation between antenna characteristic and a height of the antenna electrode 11 in a chip antenna 10E which is higher than the chip antenna 10 will be described with reference to FIGS. 11 and 12. FIG. 11 shows the height of the antenna electrode 11 in the chip antenna 10E. FIG. 12 shows a return loss with respect to frequency in the chip antenna 10 when the height of the antenna electrode 11 is changed.

As shown in FIG. 11, the chip antenna 10E includes the antenna electrode 11 and a base portion 12E. A height Ah of the base portion 12E is 3 [mm] (, which is three times higher than that of base portion 12). A simulation of a return loss with respect to frequency of the chip antenna 10E was performed in a state where the height of the antenna electrode 11 in the base portion 12E was changed from 0.7 Ah to 1.0 Ah.

As shown in FIG. 12, the return loss becomes the widest-band when the height of the antenna electrode 11 is 1.0 Ah. However, a shifting operation of a resonance portion of the height 0.7 Ah or 0.8 Ah to 1.575 [GHz] is easier than a shifting operation of a resonance portion of the height 1.0 Ah to the communication 1.575 [GHz], and the former shifting operation is more practical. Therefore, it can be found that when the height of the antenna electrode 11 is 1.0 Ah (upper surface of the base portion 12E), miniaturization effect is poorer as compared with a case where the height of the antenna electrode 11 is in a range of 0.7 Ah to 0.9 Ah (a case where the height is within the base portion 12E even if only slightly). A chip antenna having a base portion of 5 [mm] height obtained the same result as that of the chip antenna 10E.

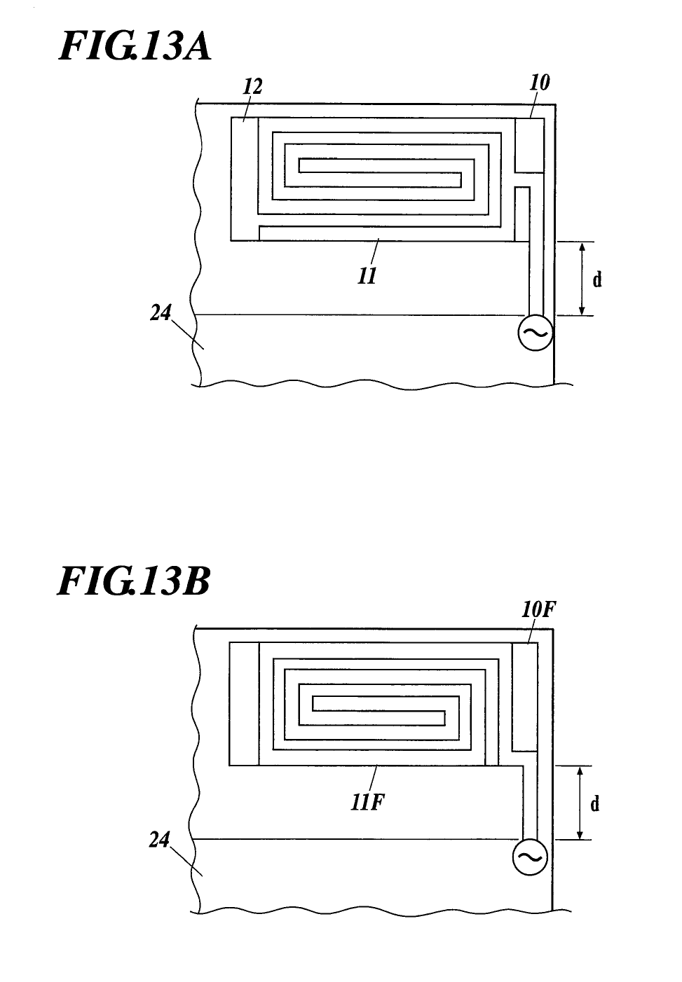

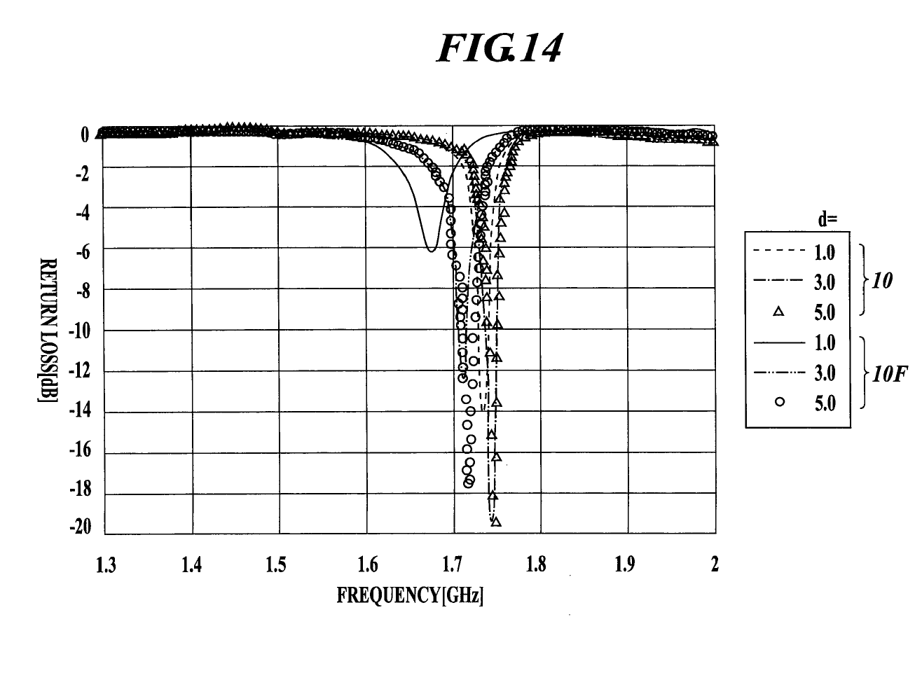

Next, a relation between antenna characteristic and a distance between the antenna electrode and the ground portion will be described with reference to FIGS. 13A to 14. FIG. 13A shows a positional relation between the chip antenna 10 and the ground portion 24. FIG. 13B shows a positional relation between a chip antenna 10F and the ground portion 24. FIG. 14 shows a return loss with respect to frequency in the chip antenna when a distance between the chip antennas 10 and 10F and the ground portion 24 is changed.

As shown in FIG. 13A, a distance between a surface of the chip antenna 10 on the side of the ground and an upper side of the ground portion 24 is defined as d. Similarly, as shown in FIG. 13B, a distance between a surface of the chip antenna 10F on the side of the ground and an upper side of the ground portion 24 is defined as d. The chip antenna 10F includes an antenna electrode 11E and the base portion 12. The antenna electrode 11E has a normal spiral shape. That is, an end point of the antenna electrode 11E is connected for feeding power.

A simulation of the antenna efficiency and a return loss with respect to frequency when the distances d in the chip antennas 10 and 10F were changed to 1.0, 3.0 and 5.0 [mm] was performed.

Antenna efficiencies of the chip antennas 10 and 10F when the distances d are changed are shown in the attached Table 4. This antenna efficiency is obtained when the frequency is 1.575 [GHz].

According to Table 4, the antenna efficiency of the chip antenna 10 is more preferable than that of the chip antenna 10F. As shown in FIG. 14, since a difference between the return losses with respect to frequencies of the chip antennas 10 and 10F is only approximately 0.1 dB when the distance d is 5.0 [mm], if the distance is longer than 5.0 [mm], the return loss of the chip antenna 10F becomes more preferable than that of the chip antenna 10.

According to the embodiment, the chip antenna 10 includes the base portion 12, the spiral antenna electrode 11 which is opposed to the ground portion 24 and provided in the base portion 12, and the power feeding connecting terminal 13 for feeding power to the antenna electrode 11. The side portion S1 including the outermost peripheral end of the antenna electrode 11 is disposed at the position closest to the ground portion 24 at the predetermined distance away from the ground portion 24. The power feeding connecting terminal 13 is connected to the second side portion S2 from the outermost peripheral end of the antenna electrode 11. Therefore, the base portion 12 and the spiral shape of the antenna electrode 11 can reduce the chip antenna 10 in size, and since the antenna electrode 11 has the spiral shape on the same plane, the productivity can be enhanced. Since the power feeding connecting terminal 13 is connected to the side portion S2, the impedance match and the antenna efficiency can be enhanced.

By providing the antenna electrode 11 in the base portion 12, effect of miniaturization of permittivity can be effectively obtained, and desired antenna characteristic can be obtained even if the permittivity is not excessively increased. As a result, it is possible to suppress the deterioration in radiation efficiency (antenna efficiency) caused by increase in capacitance.

The resonance frequency of the chip antenna 10 is adjusted to frequency higher than frequency used for communication, and the matching circuits 23a and 23b shift the resonance frequency of the chip antenna 10 to the frequency used for the communication. As a result, the chip antenna 10 can further be reduced in size.

The chip antenna 10C includes the antenna electrode 11C, the base portion 12 and the power feeding connecting terminal 13. The chip antenna 10D includes the antenna electrode 11D, the base portion 12 and the power feeding connecting terminal 13. The second side portion connected to the first side portion including the outermost peripheral end of the antenna electrode 11C or 11D is disposed at the position closest to the ground portion 24 at the predetermined distance away from the ground portion 24. The power feeding connecting terminal 13 is connected to the side portion extending in a direction perpendicular (substantially perpendicular) to the ground portion 24 of the outermost periphery of the antenna electrode 11C or 11D. Therefore, according to the chip antenna 10C or 10D, in the same manner as in the case of the chip antenna 10, the chip antenna 10 can be reduced in size by the base portion 12 and the spiral shape of the antenna electrode 11C or 11D. Since the antenna electrode 11C or 11D has the spiral shape on the same plane, the productivity can be enhanced. Since the power feeding connecting terminal 13 is connected to the side portion extending in the direction perpendicular (substantially perpendicular) to the ground portion 24, the impedance match and the antenna efficiency can be enhanced.

### First Modification

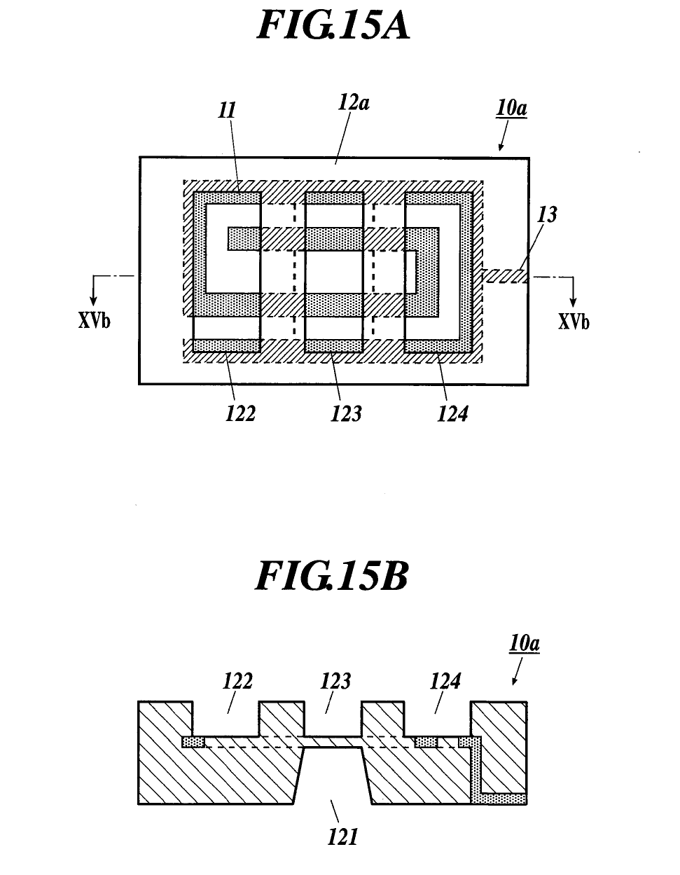

A first modification will be described with reference to FIGS. 15. FIG. 15A shows a configuration of a chip antenna 10a of the first modification as viewed from above. FIG. 15B shows a configuration of the chip antenna 10a in section taken along the line XVb-XVb in FIG. 15A.

In the chip antenna 10 of the aforementioned embodiment, the upper surface and the lower surface of the antenna electrode 11 are covered with the base portion 12. In the first modification, the chip antenna 10 is replaced by the chip antenna 10a. The chip antenna 10a has a portion which is not covered with the upper surface and the lower surface of the antenna electrode 11.

As shown in FIGS. 15A and 15B, the chip antenna 10a includes the antenna electrode 11, a base portion 12a and the power feeding connecting terminal 13. The antenna electrode 11 is provided inside the base portion 12a. The base portion 12a has a hole 121 in a lower surface of the antenna electrode 11, and holes 122, 123 and 124 in an upper surface of the antenna electrode 11.

According to the first modification, the same effect as that of the chip antenna 10 can be obtained by the chip antenna 10a, the material of the base portion 12a can be reduced by the holes 121, 122, 123 and 124, and the chip antenna 10a can be reduced in weight.

### Second Modification

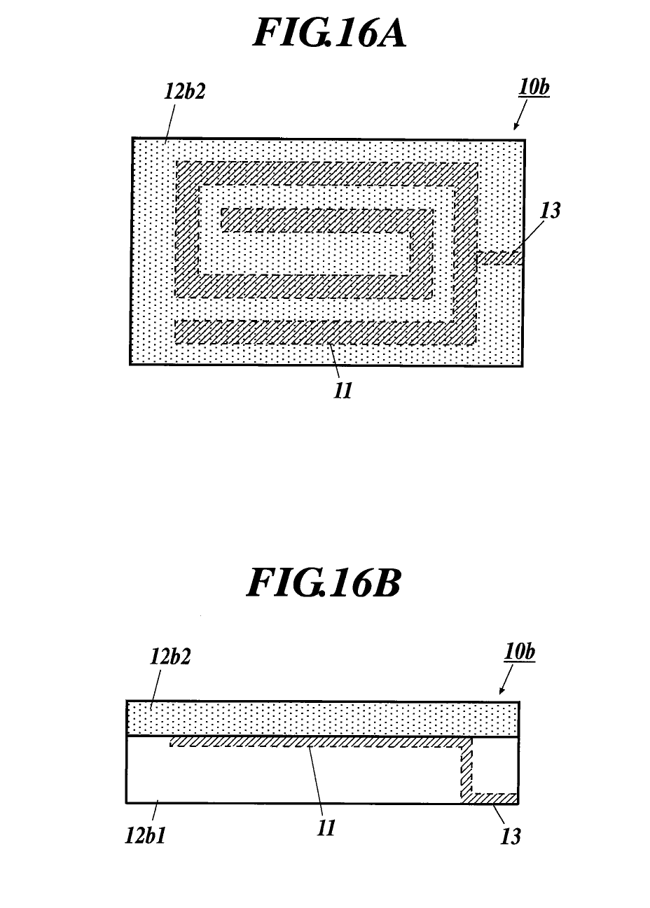

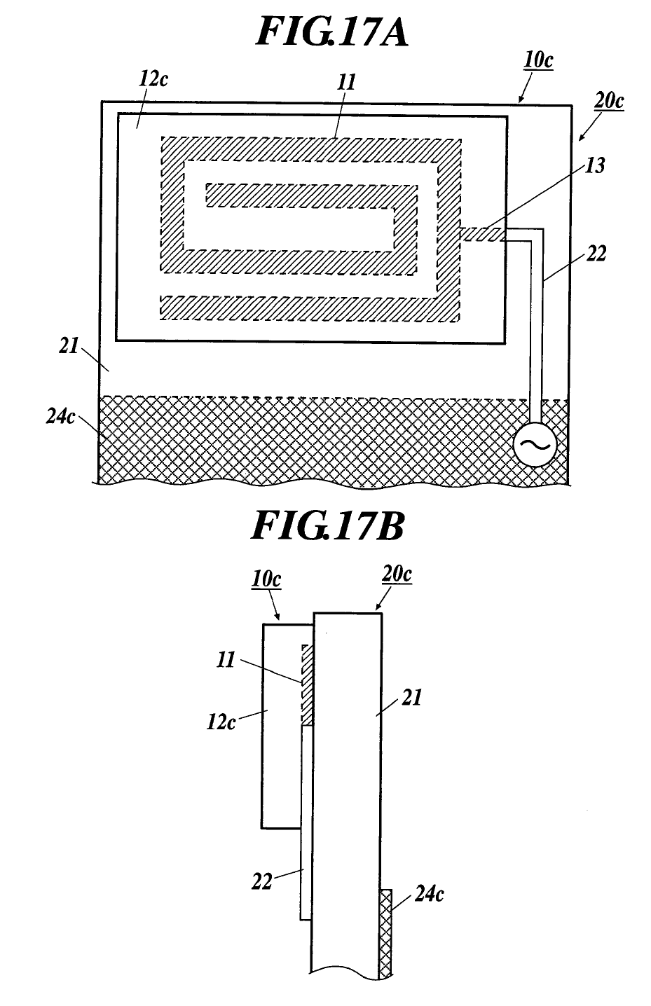

A second modification of the aforementioned embodiment will be described with reference to FIGS. 16A and 16B. FIG. 16A shows a configuration of a chip antenna 10b of the second modification as viewed from above. FIG. 16B shows a configuration of the chip antenna 10b as viewed from side.

In the chip antenna 10 of the aforementioned embodiment, the base portion 12 is formed by a single member (one layer). In the second modification, the chip antenna 10 is replaced by the chip antenna 10b. In the chip antenna 10b, the base portion is divided into two layers from the antenna electrode 11. Incidentally, the base portion may also include three or more layers.

As shown in FIGS. 16A and 16B, the chip antenna 10b includes the antenna electrode 11, base portions 12b1 and 12b2 and the power feeding connecting terminal 13. The antenna electrode 11 is provided inside the base portions 12b1 and 12b2. The base portion 12b1 is disposed on the side of the lower surface of the antenna electrode 11. The base portion 12b2 is disposed on the side of the upper surface of the antenna electrode 11. A relative dielectric constant of the base portion 12b1 may be different from or the same as that of the base portion 12b2.

According to the second modification, the same effect as that of the chip antenna 10 can be obtained by the chip antenna 10b. In addition, thicknesses (length in a direction perpendicular to the substrate portion 21) of the base portions 12b1 and 12b2 may be different from each other.

### Third Modification

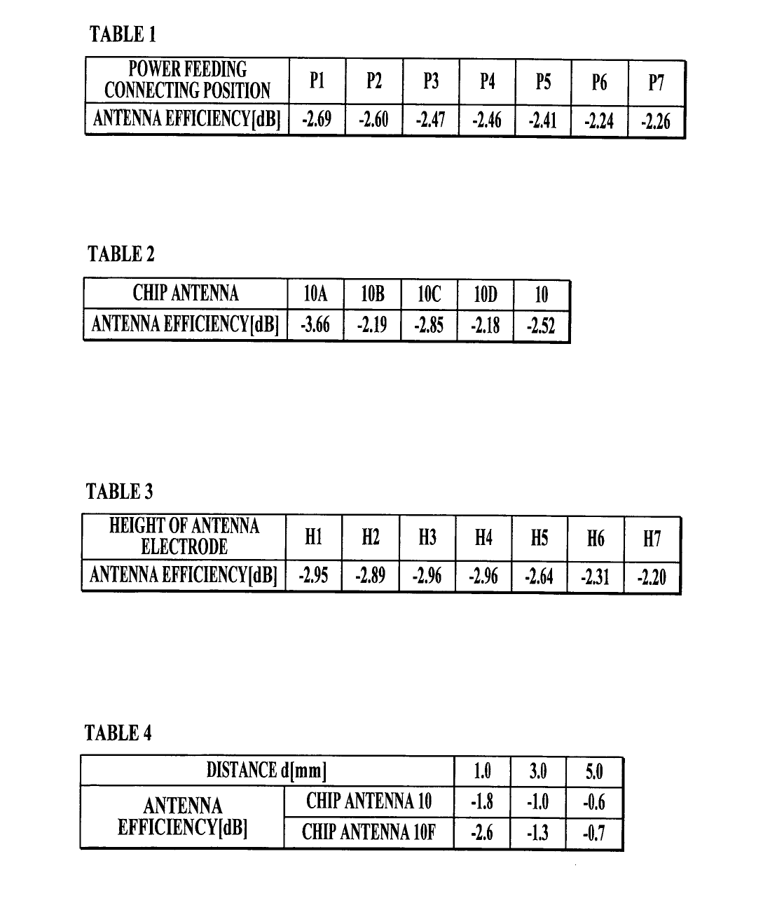

A third modification will be described with reference to FIGS. 17A and 17B. FIG. 17A shows a configuration of a chip antenna 10c of the third modification as viewed from above. FIG. 17B shows a configuration of the chip antenna 10c as viewed from side.

In the chip antenna 10 of the aforementioned embodiment, the upper surface and the lower surface of the antenna electrode 11 are covered with the base portion 12. In the third modification, the chip antenna 10 and the ground portion 24 are replaced by the chip antenna 10b and a ground portion 24c. In the chip antenna 10C, the antenna electrode 11 is mounted on the substrate portion 21.

As shown in FIG. 17A, the chip antenna 10C includes the antenna electrode 11, a base portion 12c and the power feeding connecting terminal 13. A substrate 20c includes the substrate portion 21, the power feeding path portion 22 and a ground portion 24c. As shown in FIG. 17B, the antenna electrode 11 is provided on a surface of the substrate portion 21. The base portion 12c is provided such as to cover an upper surface of the antenna electrode 11. The ground portion 24c is provided on a surface opposite from a mounting side of the chip antenna 10C. That is, the chip antenna 10C has such a positional relation that the substrate portion 21 is interposed between the chip antenna 10C and the ground portion 24c. This positional relation corresponds to a positional relation between the chip antenna 10 and the ground portion 24. The chip antenna 10C may utilize the substrate portion 21 in this manner.

According to the third modification, the same effect as that of the chip antenna 10 can be obtained by the chip antenna 10C, the substrate portion 21 can effectively be utilized, and the chip antenna can easily be produced.

The description of the embodiment and the modifications is one example of the chip antenna of the present invention, and the invention is not limited to the embodiment and the modifications.

At least two of the embodiment and the modifications may appropriately be combined. Configurations of the modifications may be combined in the chip antenna 10C or 10D. Although the chip antenna includes the installation terminal 14 in the embodiment, the invention is not limited to this, and the chip antenna need not include the installation terminal 14.

Although the base portion is the dielectric in the embodiment and the modifications, the invention is not limited to this. The base portion may be a magnetic substance or a magnetic dielectric. Also when the base portion is the magnetic substance or the magnetic dielectric, the wavelength shortening effect is generated by the relative susceptibility of the magnetic substance, or the relative dielectric constant and the relative susceptibility of the magnetic dielectric, and the chip antenna can be reduced in size.

The detailed configurations and detailed operations of the chip antennas of the embodiment and the modifications can appropriately be changed within a range not departing from the subject matter of the invention.

According to an aspect of the preferred embodiments of the present invention, there is provided a chip antenna comprising:

a base portion including a dielectric, a magnetic substance or a magnetic dielectric;

a spiral antenna electrode which is opposed to a ground portion and which is provided inside the base portion; and

a power feeding connecting terminal to feed power to the antenna electrode, wherein

a first side portion including an outermost peripheral end of the antenna electrode, or a second side portion connected to the first side portion including the outermost peripheral end, is disposed at a position closest to the ground portion at a predetermined distance away from the ground portion, and

the power feeding connecting terminal is connected to a side portion extending in a direction substantially perpendicular to the ground portion.

Preferably, the first side portion is disposed at a position on a side where the ground portion is located.

Preferably, resonance frequency of the base portion, the antenna electrode and the power feeding connecting terminal is adjusted to a value higher than frequency used for communication, and

the resonance frequency is shifted by a matching circuit to the frequency used for the communication.

Preferably, the base portion includes a hole through which a portion of the antenna electrode is exposed.

Preferably, the base portion comprises a plurality of layers.

Preferably, the antenna electrode is provided on a substrate portion, and is covered with the base portion.

According to the embodiments of the present invention, it is possible to reduce the antenna in size, and to enhance the impedance match and the antenna efficiency.

The entire disclosure of Japanese Patent Application No. 2009-289960 filed on Dec. 22, 2009 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A chip antenna comprising:
a base portion including a dielectric, a magnetic substance or a magnetic dielectric;
a spiral antenna electrode which is opposed to a ground portion and which is provided inside the base portion; and
a power feeding connecting terminal to feed power to the antenna electrode, wherein
a first side portion including an outermost peripheral end of the antenna electrode, or a second side portion connected to the first side portion including the outermost peripheral end, is disposed at a position closest to the ground portion at a predetermined distance away from the ground portion, and
the power feeding connecting terminal is connected to a side portion extending in a direction substantially perpendicular to the ground portion.

2. The chip antenna according to claim 1, wherein the first side portion is disposed at a position on a side where the ground portion is located.

3. The chip antenna according to claim 1, wherein resonance frequency of the base portion, the antenna electrode and the power feeding connecting terminal is adjusted to a value higher than frequency used for communication, and
the resonance frequency is shifted by a matching circuit to the frequency used for the communication.

4. The chip antenna according to claim 1, wherein the base portion includes a hole through which a portion of the antenna electrode is exposed.

5. The chip antenna according to claim 1, wherein the base portion comprises a plurality of layers.

6. The chip antenna according to claim 1, wherein the antenna electrode is provided on a substrate portion, and is covered with the base portion.
